(19) United States
(12) Patent Application Publication
(10) Pub. No.: US 2016/0137154 A1
(43) Pub. Date: May 19, 2016

(54) INTERIOR TRIM PART AND METHOD FOR ITS MANUFACTURE

(71) Applicant: International Automotive Components Group GmbH, Düsseldorf (DE)

(72) Inventors: Anna SASU, Dusseldorf (DE); Helmut BERGERS, Dusseldorf (DE); Stephan PETERS, Dusseldorf (DE); Dieter SCHARF, Ebersberg (DE)

(21) Appl. No.: 14/943,828

(22) Filed: Nov. 17, 2015

(30) Foreign Application Priority Data
Nov. 18, 2014 (DE) 10 2014 116 813.5

(51) Int. Cl. B60R 21/2165; B60R 13/02

(52) U.S. Cl. CPC B60R 21/2165; B60R 13/02; B60R 2013/0287

(57) ABSTRACT

The disclosure pertains to an interior trim part including a support component and a decorative layer, wherein the support component and the decorative layer respectively include a local weakening along a weakening line that makes it possible to tear open the interior trim part in a controlled fashion when a predefined force is exerted upon the support component, and further including an intermediate layer between the support component and the decorative layer, wherein the intermediate layer is bonded to the decorative layer and includes an intermediate layer weakening that intersects the weakening line.

### BACKGROUND

The disclosure is directed at an interior trim part for a motor vehicle such as an instrument panel, into which an airbag cover is integrated. The interior trim part includes a decorative layer that may consist of leather or a leather-like material such as synthetic leather, Alcantara or a leather composite material. The decorative layer may also be composed of or contain textiles, non-woven fabrics (also referred to as formed fabric or fleece), thermoplastic or thermosetting plastics, e.g. in the form of films or skins, or combinations of these materials.

DE 10 2009 008 726 A1 discloses an airbag cover that comprises: a trim part, a visible cover of leather or leather-like material that covers the trim part and a foam layer between the trim part and the visible cover. Furthermore, an intermediate layer with a higher modulus of elasticity than the visible cover such as, for example, a film, knitted fabric or woven fabric, is inserted between the foam layer and the visible cover. In order to produce a tear line, a shared weakening is formed in the trim part, the foam layer and the intermediate layer whereas the visible cover itself is not weakened and also includes no reduction of its wall thickness so as to not impair the aesthetic appearance of the visible cover.

DE 10 2006 055 861 B3 describes an interior trim part for covering an airbag with a support component, an intermediate layer of a knitted spacer fabric and a decorative surface layer of leather or synthetic leather. In order to produce a tear line, the support component and the knitted spacer fabric are completely separated along the tear line with the exception of a few remaining webs or otherwise weakened whereas the decorative surface layer does not feature any local weakening and also no seam. Instead, a planar adhesive connection between the decorative surface layer and the intermediate layer is recessed in a strip with a width of about 4 mm that extends along the tear line.

DE 10 2009 043 498 A1 describes another interior trim part with a support component, an intermediate layer and a decorative layer, wherein the support component and the intermediate layer are weakened in order to produce a tear line, but the decorative layer does not feature any weakening in the region of the tear line.

In the two latter-mentioned publications, the decorative surface itself is not weakened in order to prevent the tear line from being noticeable on the visible side of the interior trim part. However, other measures such as the incorporation of an intermediate layer or the recessing of an adhesive connection in the region of the tear line are taken in order to still ensure that the airbag cover is torn open when the airbag is triggered.

In the manufacture of interior trim parts that comprise an airbag cover, particularly interior trim parts with a decorative layer of leather or a leather-like material that provides the interior trim part with a top-quality appearance, the design engineers constantly search for an optimal compromise between a reliable and controllable tearing behavior of the airbag cover when the airbag is triggered and the highest possible quality of its appearance, wherein the visibility of the tear lines should be reduced to a minimum or the tear lines should not be visible at all.

EP 2 684 745 A1 proposes an instrument panel for a motor vehicle, into which an airbag cover is integrated, wherein the airbag cover features a support component, a decorative layer of leather or a leather-like material and a spacer layer between the support component and the decorative layer. The support component, the decorative layer and the spacer layer respectively feature a local material weakening that forms a tear line and allows the interior trim part to tear open in a controlled fashion when the airbag is triggered. In order to prevent this material weakening from being noticeable on the upper side of the decorative layer, an intermediate layer without local weakening is incorporated between the decorative layer and the spacer layer. The intermediate layer may consist of a non-woven fabric that is composed of individual fibers, wherein this non-woven fabric—in contrast, e.g., to woven fabrics, knitted fabrics or knitted fabrics of yams—only has a low cohesion and can also be easily torn open without a separate local weakening.

The tearing behavior of an interior trim part, into which an airbag cover is integrated, is improved without the airbag cover being optically and/or haptically noticeable on the visible side of the interior trim part.

The interior trim part according to one example comprises a support component and a decorative layer, wherein the support component and the decorative layer respectively include a local weakening along a weakening line that makes it possible to tear open the interior trim part in a controlled fashion when a predefined force is exerted upon the support component. The weakening line may define an airbag cover. An intermediate layer is arranged between the support component and the decorative layer, wherein the intermediate layer is bonded to the decorative layer and includes a weakening such as, e.g., a perforation that intersects the weakening line. The perforation does not follow the weakening line, but rather extends along one or more perforation lines that extend obliquely to and intersect the weakening line in one or more intersecting points. The arrangement of the weakening lines ensures that at least an initial tear is also formed in the intermediate layer when the interior trim part is torn open along the weakening line such that the intermediate layer does not impair the tearing behavior. Due to the oblique arrangement of the weakening lines, the intermediate layer also has a significantly higher tensile strength in the direction perpendicular to the weakening line than an intermediate layer that is conventionally weakened along and parallel to the weakening line of the support component and the decorative layer. In this way, the intermediate layer can stabilize the underside of the decorative layer, as well as prevent the formation of a gap in the decorative layer along the weakening line and thereby prevent the material weakening from becoming noticeable on the upper side of the decorative layer.

In the context of this application, the term perforation may refer to a perforation, opening or hole that completely penetrates a material layer or to an opening, scoring, notching or the like that only partially penetrates the material layer and weakens the material along the perforation line. The perforation can be formed by means of cutting, punching, scoring, embossing or similar processing of the material.

In one example, the perforation is realized along several parallel or essentially parallel perforation lines that extend obliquely to and intersect the weakening line in several intersecting points. The perforation lines extend at an angle other than 90 degrees relative to the weakening line, e.g. at an angle between 20 degrees and 70 degrees, or between 30 degrees and 60 degrees. The perforations do not have to form straight lines, but rather may also be realized, e.g., in the form of wavy lines or zigzag lines. In this case, the “direction” of the perforation line refers to its principal direction that is defined by the connection between its two end points.

In one example, the perforation is realized along a first group of parallel or essentially parallel perforation lines and a second group of parallel or essentially parallel perforation lines, wherein the perforation lines of the first group and the perforation lines of the second group cross one another. In this way, an intermediate layer can be realized with a grid of perforation lines and applied on the support component. The perforation lines therefore can be arranged independently of the exact location and direction of the weakening line and still extend obliquely thereto.

In order to improve the stability of the intermediate layer, the perforations arranged along the perforation lines of the first group and the second group may be provided without contacting or intersecting one another.

In one example, the perforation lines of the first group and the perforation lines of the second group are arranged relative to one another at an angle between 90 degrees and 170 degrees, or between 90 degrees and 120 degrees.

In one example, the intermediate layer is flatly arranged on an airbag cover formed in the interior trim part and spans the airbag cover and the weakening line, wherein the weakening line defines the airbag cover. The intermediate layer may also be applied over the entire surface or essentially the entire surface of the interior trim part.

The airbag cover typically includes one or more primary tear lines that are aligned along a first direction and a second direction defined by the weakening line, wherein the first direction may extend perpendicular or about perpendicular to the second direction. For example, the airbag cover may have an essentially rectangular contour with a hinge along one longitudinal edge of the airbag cover and tear lines along the opposite longitudinal edge and the lateral edges. In this case, the perforation line should extend obliquely to the first direction and the second direction, i.e. obliquely to the longitudinal edges and the lateral edges of the rectangular airbag cover in this example.

The intermediate layer may include a carrier layer and one or two adhesive layers.

The intermediate layer may comprise or be made of paper, non-woven fabrics, textiles or woven fabrics and combinations of these materials. In one example, the intermediate layer consists of a non-woven fabric material, such as fleece. The non-woven fabric material forms a bonded web, the tearing behavior of which may be similar, for example, to that of a fibrous material cloth or tissue or the like. Examples of possible materials for the bonded web are thermobonded non-woven fabrics starting at a weight per unit area, e.g., of about 15 g/m³, hydro-entangled non-woven fabrics starting at a weight per unit area, e.g., of about 35 g/m³ and needle-punched non-woven fabrics starting at a weight per unit area, e.g., of about 60 to about 250 g/m³. In one example, the non-woven fabric material has a thickness of 15 to 30 g/m³, for example about 20 g/m³. The non-woven fabrics may be manufactured of a synthetic fiber material such as, e.g., PP, PE, PET, PA, PAN, viscose, etc., or consist of mixed fibers such as, e.g., PP-PE, PP-PET, PET-BicoPET, PET-viscose, etc. For example, non-woven fabrics of PET or mixed fibers are advantageous in comparison with non-woven fabrics of PP due to the adhesive bond. The thickness of the non-woven fabrics may lie on the order, e.g., of about 0.08 mm to 0 5 mm or 0.08 mm to 0.2 mm and amount, for example, to about 0.1 mm

The intermediate layer may generally include natural fibers, synthetic fibers or a mixture of natural and synthetic fibers. It would also be possible to use an intermediate layer in the form of a very thin film that can be easily torn open instead of a non-woven fabric.

In one example, a spacing layer may furthermore be provided between the support component and the decorative layer, wherein said spacing layer also includes a local weakening along the weakening line. When the intermediate layer lies between the decorative layer and the spacing layer, the intermediate layer can also stabilize the spacing layer and prevent the spacing layer from forming a noticeable gap in the region of the weakening line. In this example, an additional (optional) intermediate layer may furthermore be arranged between the support component and the spacing layer.

In one example, the spacing layer includes a woven or knitted spacing fabric. It would alternatively also be possible to realize the spacing layer, for example, in the form of a foam layer.

In one example, the material weakening of the spacing layer is realized in such a way that the spacing layer is at least sectionally separated over its entire thickness. To this end, the spacing layer may be completely separated along the entire weakening line or webs may remain between individual cuts. In another example, the spacing layer may be applied in the form of individual prefabricated layer segments.

The decorative layer may consist of leather or a leather-like material. Leather-like materials include materials that are characterized by performance characteristics and potential applications similar to those of genuine leather. These materials may be made of leather remnants or waste leather or consist of synthetic leather. The decorative layer may also be composed of or contain textiles, non-woven fabrics, thermoplastic or thermosetting plastics, e.g., in the form of films or skins or combinations of these materials.

In one example, the material weakening of the decorative layer is formed with one or more cuts in the underside of the decorative layer, wherein these cuts only separate the decorative layer over part of its thickness, for example by about ⅔. In one example, a residual material thickness between 0.4 and 0.5 mm may remain. It would also possible to produce the weakening in the decorative layer in a different way, e.g. by means of scarfing or grinding.

In one example, a foam layer is applied onto the support component and a plastic skin lies on top of the foam layer, wherein the decorative layer or the spacing layer can then be directly or indirectly applied onto the plastic skin. In this example, the foam layer and the plastic skin should also include a local material weakening in the region of the weakening line. This material weakening may be realized in such a way that the support component and the plastic skin are at least sectionally separated over the entire thickness whereas the foam layer is only separated over part of its thickness from the side of the support component.

The preceding example is particularly suitable for applications, in which the support component has a surface structure, e.g. with beads and ribs, that does not correspond to the desired surface design of the interior trim part. In this case, the plastic skin may be realized, e.g., in the form of a slush skin such that its structure essentially corresponds to the desired surface structure of the interior trim, wherein the intermediate space between the support component and the plastic skin can be filled with a foam such that the so formed foam layer has an uneven thickness over the surface of the interior trim part and compensates the differences between the surface structures of the support component and the plastic skin.

The intermediate layer may be provided in the form of a strip only in the region of the weakening line or over the entire surface between the decorative layer and the spacing layer or between the decorative layer and the support component. It conceals the weakening line such that this weakening line is optically and haptically unnoticeable from outside. This concealment of the weakening in the spacing layer and the decorative layer is particularly relevant with respect to interior trim parts that have already undergone a certain aging process, during which a gap can form in the spacing layer and the decorative layer along the weakening line. This is particularly important if a spacing layer is used and said spacing layer is realized, e.g., in the form of a knitted or woven fabric that is completely separated in the region of the weakening line.

It is also possible to form the intermediate layer of two or more layers such as, e.g., two non-woven fabric layers of identical or different quality, of a bonded web in combination with a film or the like. One of the layers could be applied directly onto the underside of the decorative layer in order to hold together one or more cuts that may form the weakening. A second layer can be directly applied onto the support component or the spacing layer before connecting the decorative layer and the support component or connecting the decorative layer and the spacing layer.

The example of the interior trim component described above can be manufactured in that a carrier layer is provided, the carrier layer is coated with an adhesive in order to produce an intermediate layer with an adhesive coating on each side of the carrier layer, and the support component, the spacing layer and the decorative layer are then assembled into a sandwich structure, wherein the spacing layer and the decorative layer are bonded to one another by means of the intermediate layer.

For example, the method may specifically comprise the following: a support component is initially produced, for example, by injection molding of a plastic support or by press-forming a composite fiber material. The support component is weakened, for example, by cutting or milling a groove that forms a weakening line. This groove may at least sectionally separate the support component over its entire thickness. A spacing layer is directly or indirectly applied onto the support component, wherein the spacing layer is weakened such as, in particular, discontinuously or continuously interrupted in the region of the weakening line. A decorative layer is applied onto the spacing layer, e.g., by means of laminating or bonding, wherein the decorative layer likewise includes a structural weakening in the region of the weakening line. The intermediate layer is placed between the decorative layer and the spacing layer before or during the application of the decorative layer. The intermediate layer may be initially placed onto the spacing layer before the decorative layer is laminated thereon. It would also be possible to initially connect the intermediate layer to the decorative layer, which was already provided with the structural weakening, and to subsequently apply the decorative layer onto the spacing layer together with the intermediate layer. It is also possible to use a multilayered intermediate layer that is placed between the decorative layer and the spacing layer or initially connected to the decorative layer and/or the spacing layer as a whole or with its individual layers.

The above-described method implies that a spacing layer is provided. This spacing layer can also be eliminated or replaced or supplemented with other layers. The intermediate layer may be realized in the form of an adhesive layer in that a perforated carrier layer is coated or impregnated with adhesive on one or both sides.

In one example, the manufacture of the interior trim part also includes forming a plastic skin that largely corresponds to the desired surface structure of the interior trim part. It may consist, for example, of a slush skin. Then, the molded support component and the plastic skin are placed into a mold and a mold cavity formed between the support component and the plastic skin is filled with a foam material. The plastic skin can be weakened with one or more cuts in order to produce a tear line and the composite consisting of the support component and the foam layer molded on the support component can be weakened, e.g., by cutting or milling a groove from the side of the support component. This groove may at least sectionally extend through the entire thickness of the support component and through part of the thickness of the foam layer. Subsequently, the decorative layer and, if applicable, the spacing layer, as well as the intermediate layer, can be applied onto the plastic skin in the above-described fashion, e.g., by means of bonding.

### DESCRIPTION OF DRAWINGS

Examples are described in greater detail below with reference to the figures. In these figures:

FIG. 1 shows a schematic section through an interior trim part according to an example;

FIG. 2 shows a top view of an intermediate layer according to an example;

FIG. 3 shows a top view of an intermediate layer according to an alternative example;

FIGS. 4-9 show schematic partial sections through different examples of interior trim parts; and

FIG. 10 shows a flowchart representing an example of a method for manufacturing an interior trim part according to FIGS. 1-9.

### DESCRIPTION OF EXAMPLES

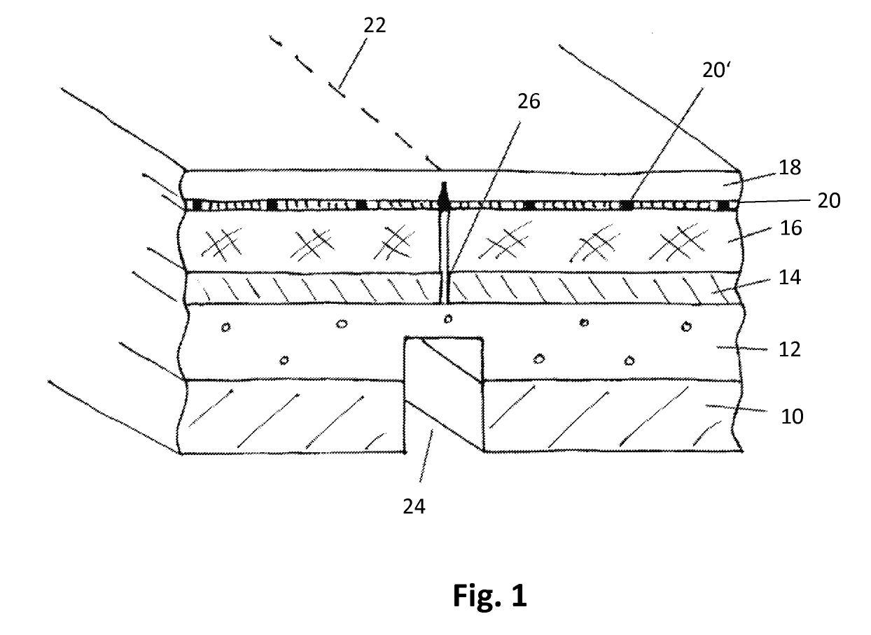

FIG. 1 shows a schematic sectional representation of one potential design of the interior trim part. In this example, the interior trim part comprises a support component 10, a foam layer 12, a plastic skin 14, a spacing layer 16 and a decorative layer 18. An intermediate layer 20 is positioned between the spacing layer 16 and the decorative layer 18.

The support component 10 may consist of an injection-molded part, e.g., of polypropylene, ABS or any other suitable plastic that may optionally contain fibers such as, e.g., glass fibers or carbon fibers. It may also be realized in the form of a fiber mat produced by means of heating and press-forming It is possible to use any support material that is suitable for the intended use, for example, as an instrument panel of a motor vehicle.

For example, the plastic skin 14 is realized in the form of a slush skin of PVC, PPO or another plastic and separately molded beforehand. The plastic skin 15 is expandable relative to the support component. It has a thickness, for example, in the range between 0.8 and 1.4 mm The plastic skin 14 can be realized in such a way that it largely corresponds to the desired surface structure of the interior trim part.

The foam layer 12 lying between the support component 10 and the plastic skin 14 may be produced, for example, from polyurethane (PUR) by filling the space between the support component 10 and the plastic skin 14 with foam. Over its surface, the foam layer 12 may have an uneven thickness in the range, e.g., between 0 and 10 mm in order to compensate the different surface structures of the support component and the plastic skin 14. This makes it possible to realize the plastic skin 14 in such a way that it essentially resembles the structure of the visual surface 10 of the trim part whereas the support component may be independently realized with beads, ribs and other elements that should not be noticeable from the visible side. For example, the hardness of the foam layer 12 is in the range between 55 Shore A and 75 Shore A.

The plastic skin 14 is connected to the spacing layer 16 that may consist of a knitted or woven fabric and bonded to the plastic skin 14.

The decorative layer 18 is laminated or bonded onto the spacing layer 16. This decorative layer consists, e.g., of leather or a leather-like material. Leather-like materials include materials that are characterized by performance characteristics and potential applications similar to those of genuine leather. These materials may be made of leather remnants or waste leather and comprise, e.g., synthetic leather, Alcantara and leather composite materials. The decorative layer may also be composed of or contain textiles, non-woven fabrics, thermoplastic or thermosetting plastics, e.g., in the form of films or skins or combinations of these materials.

The intermediate layer 20 is inserted between the cover layer 18 and the spacing layer 16. It may be provided over the entire surface or over the majority of the surface of the interior trim part, e.g. over a complete airbag cover. In one example, the intermediate layer 20 comprises a non-woven fabric and is realized in the form of a bonded web that is bonded to the spacing layer 14 and the decorative layer 18. In one example, a thermobonded non-woven fabric of PET with a weight per unit area of 20 g/m³ was tested. Non-woven fabrics with a thickness in the range between about 0.1 and 0.2 mm proved suitable for use in practical applications, but the invention is by no means limited to this thickness range. For example, non-woven fabrics of PET or mixed fibers are advantageous in comparison with non-woven fabrics of PP due to the adhesive bond.

Instead of using a single-layer bonded web, the intermediate layer 20 may also be formed from two or more layers, e.g., of two non-woven fabric layers of identical or different materials and quality, of a bonded web in combination with a film or the like.

The intermediate layer 20 may serve as adhesive layer in that a non-woven fabric carrier layer is coated with adhesive on both sides, e.g., by means of rolling, spraying, doctoring or immersing, wherein the application of adhesive can be precisely metered, e.g. in the form of

intermediate layer=[carrier layer+adhesive (flashed off)] g/m³

with an adhesive content of about 120 g/m³ and a weight per unit area of the carrier layer between 15 and 30 g/m³, e.g. about 20 g/m³.

A tear line or weakening line 22 can be formed in the interior trim part illustrated in FIG. 1 as follows: after the composite consisting of the support component 10, the foam layer 12 and the plastic skin 16 has been produced, a groove 24 is milled through the support component 10 and part of the foam layer 11 from the side of the support component 10, wherein this groove may be realized continuously or discontinuously (in sections) with webs remaining in between. In addition, the plastic layer 14 is weakened in the region of the tear line 22 by means of a continuous cut or several small cuts, punctiform perforations 26 or the like, wherein these cuts are formed by means of lasers, knives, water jets, etc., and may also extend into the material of the foam layer 12.

The spacing layer 16 is then applied, wherein this spacing layer may be realized in the form of individual layer segments of a woven or knitted fabric, i.e. individual sections that are completely separated from one another and arranged, e.g., on the airbag cover and around the airbag cover. In this case, the spacing layer 16 no longer has to be cut because it is already provided in separate layer segments.

The decorative layer 18 is weakened along the tear line from its rear side, for example, by being continuously or discontinuously scored before it is applied onto the interior trim part, wherein this weakening may be realized in a straight line, in the form of a wave, a zigzag line, etc. The decorative layer may also be weakened by means of cutting, e.g. scarfing or grinding. For example, a residual material thickness of 0.45 mm should remain.

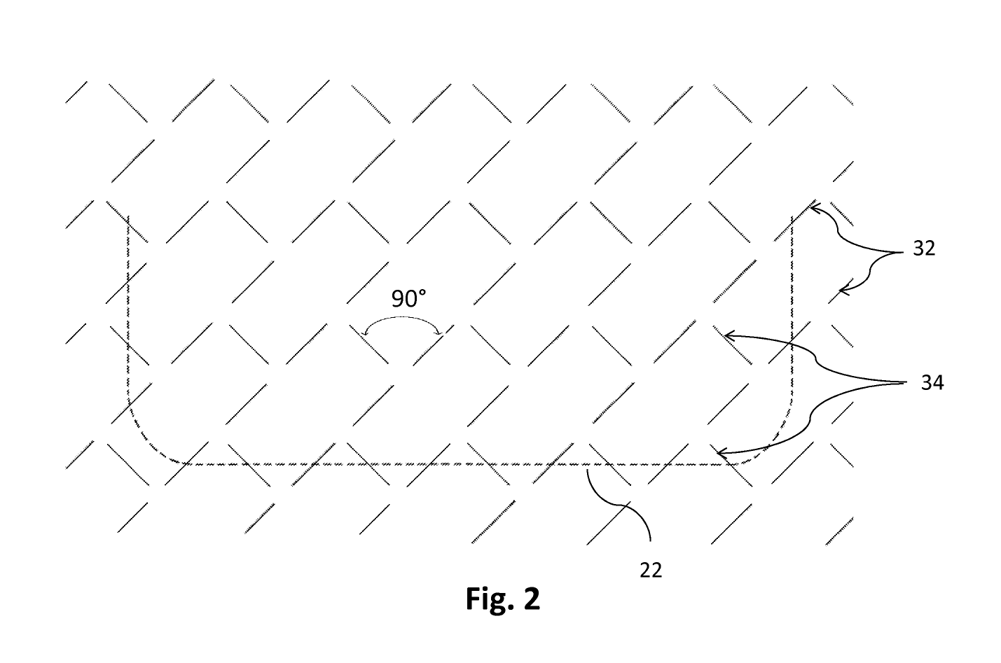

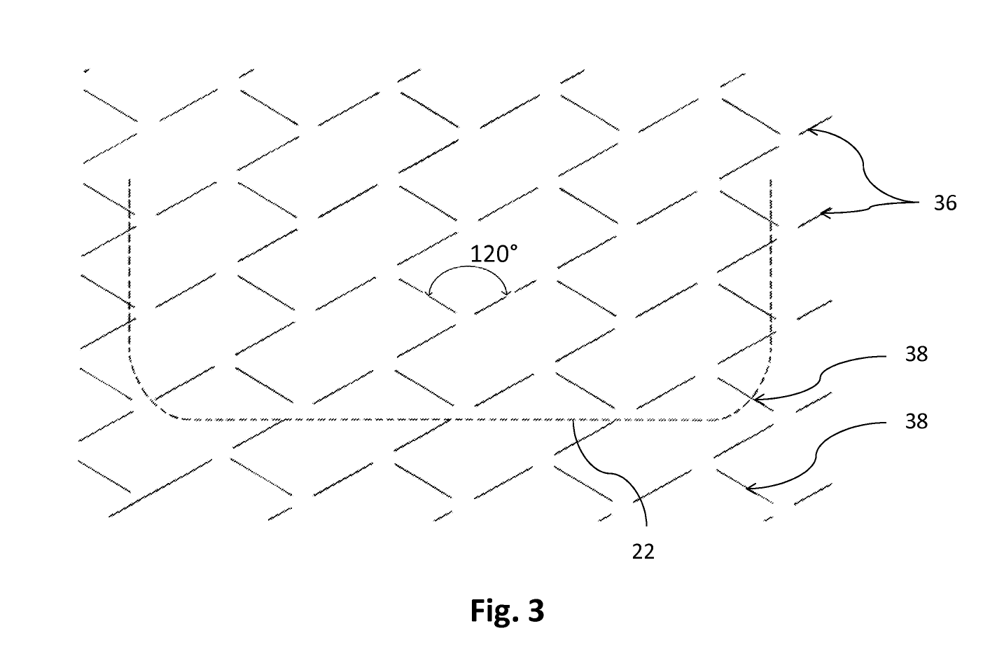

The intermediate layer 20 includes a perforation 20′ that is described in greater detail with reference to FIGS. 2 and 3.

The intermediate layer 20 may be provided over the entire surface of the spacing layer 16 or only in the region of the airbag cover, wherein the decorative layer 18 is laminated onto the spacing layer 16 after positioning the intermediate layer 20 in between. If a multilayered intermediate layer 20 is used, one of the layers can be directly applied onto the underside of the decorative layer 18 in order to hold together one or more cuts that may form a weakening. A second layer can be applied directly onto the spacing layer 16 before the decorative layer and the spacing layer are connected.

The intermediate layer 20 ensures that the adjacent material weakening in the plastic skin 14 and/or the spacing layer 16 is unnoticeable from the decorative side, neither optically nor haptically. In addition, it also stabilizes the weakening cut in the decorative layer 18 such that this cut is also unnoticeable on the visible side of the decorative layer if it is stretched, e.g., under the influence of heat or aging. Due to the special perforation, however, the intermediate layer 20 is realized in such a way that its material easily tears open when the weakening line 22 is subjected to an impact load, namely when the airbag is triggered, and therefore offers no noteworthy resistance to breaking open the interior trim.

In the example shown, the support component may have a thickness on the order, e.g., of 1 mm to 5 mm, or 2 mm to 3 mm In one example, the thickness of the support component 10 is on the order, e.g., of 2.5 mm, but this thickness depends on the material and the intended use in practical applications. As mentioned above, the foam layer typically has a varying thickness in the range, e.g., between 0 mm and 8 or 10 mm over the surface of the interior trim part. The plastic skin 14 may have a thickness on the order of 1 mm, wherein this plastic skin has a thickness of about 1.2 mm in one example. The spacing layer 16 may have a thickness on the order of about 1.5 mm to 5 mm, for example about 3 mm The decorative layer 18 may comprise, e.g., a leather layer or leather-like layer with a thickness in the range, e.g., between 0.8 and 1.5 mm, wherein the decorative layer has a thickness of about 1.2 mm in one example. The intermediate layer 20 may have a smaller thickness on the order of about 0.1 mm to 0.5 mm or even only 0.1 mm to 0.2 mm

FIGS. 2 and 3 show two top views of different examples of the intermediate layer 20 with different perforations. In FIG. 2, a perforation in the form of two groups of perforation lines 32, 34 that extend perpendicular to one another is formed in the intermediate layer 20. Each group of perforation lines 32, 34 comprises several parallel perforation lines, along which individual perforation openings or perforation cuts are produced. In one example, the individual cuts or perforation openings may have a length between 5 mm and 50 mm, e.g. about 25 mm, and the ends of the cuts may be spaced apart by a distance of 5 mm to 50 mm or 5 mm to 20 mm or by about 10 mm, 12 mm or 15 mm For example, the distance between the parallel perforation lines may lie on the order between 10 mm and 70 mm, e.g. at about 33 mm It would also be possible to only provide one group of perforation lines, for example the perforation lines 32 in FIG. 2. According to FIG. 2, the second group of perforation lines 34 may include perforations that are spaced apart by a greater distance between the ends of the cuts, wherein FIG. 2 likewise shows that the individual perforation openings of adjacent perforation lines may also be offset relative to one another. The perforation openings on the crossing perforation lines should not intersect or contact one another in order to prevent the stability of the intermediate layer 20 from being excessively impaired.

Several perforation openings can generally be provided along several perforation lines. It would be possible to provide one group of parallel perforation lines or two or more groups of such parallel perforation lines that are arranged at an angle to one another. The perforation openings of the groups of perforation lines may have different lengths and be spaced apart by different distances. The length of the individual perforation openings in a group of perforation lines is also dependent on the distance between the perforation lines of the other group. According to FIGS. 2 and 3, the perforation openings may define a grid of rectangles or diamonds, wherein individual perforation openings extend along the lateral edges of the rectangles or diamonds without contacting one another in the crossing points, and wherein individual lateral edges, in a regular or irregular pattern, also may include no perforation openings.

The groups of perforation lines 32, 34 are arranged in such a way that the resulting perforations in the intermediate layer 20 intersect or are tangent to the weakening line 22. In this way, the opening performance is not impaired when the airbag is triggered because the individual perforations in the intermediate layer 20 produce one or more initial tears. The intermediate layer 20 stabilizes both the decorative layer lying thereon and the spacing layer lying thereunder, wherein the intermediate layer can absorb tensile forces that act parallel to the decorative layer and perpendicular to the weakening line 22 and thereby counteract the tendency of the decorative layer and/or the spacing layer to form a noticeable gap in the region of the weakening line.

The perforations may have different dimensions and neither have to be arranged uniformly nor provided over the entire surface of the intermediate layer 20 as long as they are arranged such that at least a few perforations intersect the weakening line 22 and the intermediate layer 20 can absorb tensile forces acting perpendicular to the weakening line 22 and thereby counteract the tendency of a widening gap being formed in the decorative layer and/or the spacing layer in the region of the weakening line.

FIG. 3 shows an alternative example of two groups of perforation lines 36, 38. In this example, the weakening lines 36, 38 comprise perforation lines that are arranged similar to FIG. 2, but aligned at an angle of 120° relative to one another. This results in different intersecting angles between the perforation lines 36, 38 and the respective longitudinal edges and lateral edges of the airbag cover along the tear line 22. The tensile force to be absorbed by the intermediate layer 20 can be adjusted by different angles of inclination between the respective groups of perforation lines 32, 34 and 36, 38. The number, length and spacing between the individual perforation openings represent other factors.

As mentioned above, the intermediate layer 20 is in an example realized in the form of a carrier layer that is coated with an adhesive and therefore also serves as an adhesive layer between the decorative layer and the support component or between the decorative layer and the spacing layer, wherein additional structural layers may be inserted, if so required. This allows a more economical adhesive coating than the coating of a contoured support component and a decorative layer and/or spacing layer with adhesive. Since the decorative layer and the spacing layer or the support component do not have to be coated with an adhesive, it is furthermore possible to lower the risk of gluing together the weakening line due to the inflow of wet adhesive and thereby negatively influencing the opening behavior of the airbag.

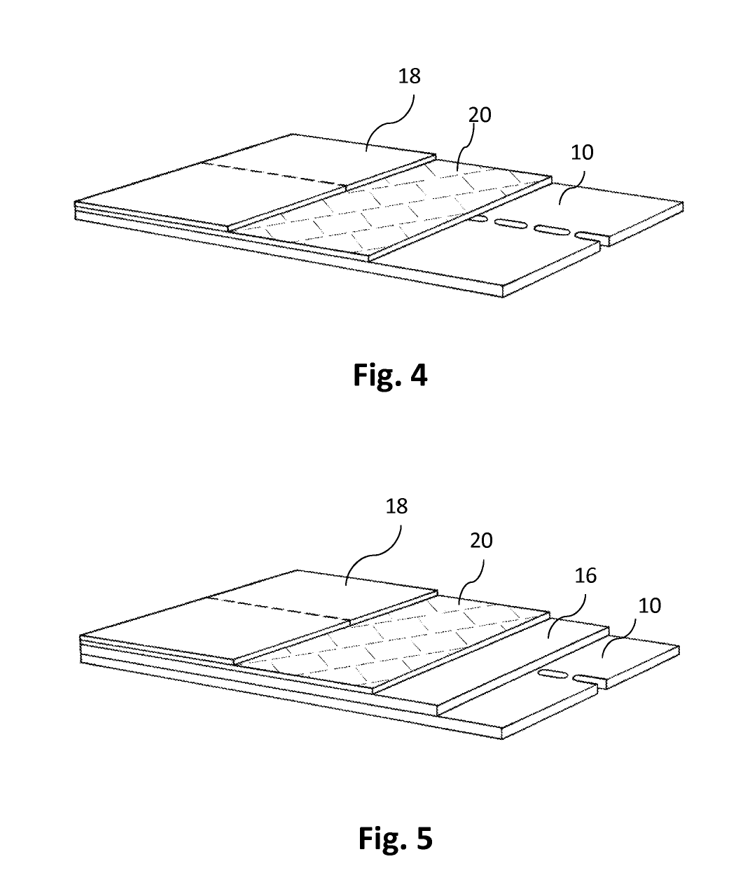

FIGS. 4 to 9 show different examples of the interior trim part that comprises at least the support component 10, the intermediate layer 20 and the decorative layer 18 as illustrated in FIG. 4.

In the example according to FIG. 5, the interior trim part comprises the support component 10, onto which a spacing layer 16 is applied, and a decorative layer 18 that is connected to the spacing layer 16 by means of the intermediate layer 20.

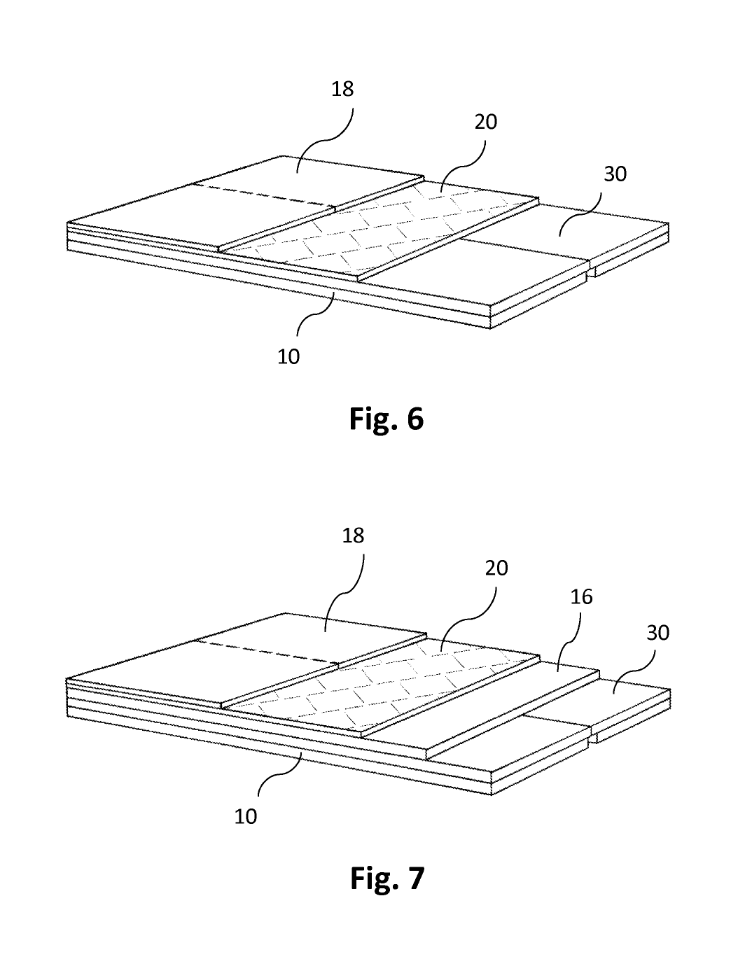

In the example according to FIG. 6, the interior trim part comprises a support component 10, onto which a film or cellular film 30 is laminated, and a decorative layer 18 that is connected to the film 30 by means of the intermediate layer 20.

In the example according to FIG. 7, the interior trim part comprises a support component 10, onto which a film or cellular film 30 is laminated. A knitted spacing fabric 16 is applied onto the film 30. The decorative layer 18 is connected to the spacing layer 16 by means of the intermediate layer 20.

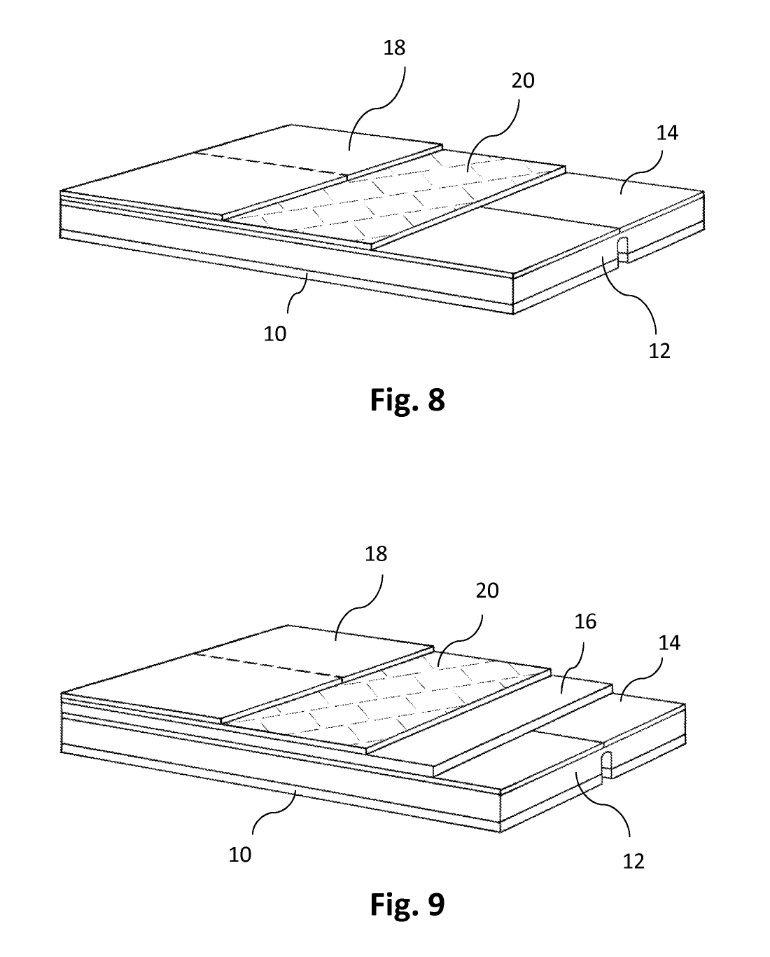

In the example according to FIG. 8, the interior trim part comprises the support component 10, onto which a structural layer 12, 14 is applied. This structural layer may include a slush skin, spray-on skin or thermoformed skin 14, wherein a foam layer is incorporated between the support component 10 and the skin 14, for example, in the above-described fashion. A decorative layer 18 is applied onto the skin 14 by means of the intermediate layer 20.

The example according to FIG. 9 essentially corresponds to the structure illustrated in FIG. 1 and comprises a support component 10, a foam layer 12, a plastic skin 14, a spacing layer 16, the intermediate layer 20 and a decorative layer 18. The preceding description basically applies to all components of the examples illustrated in FIGS. 4 to 9, for example, with respect to their materials, thicknesses and production methods. The individual layers may be formed by means of bonding, laminating and, as far as the support component and additional structural layers are concerned, also by means of back-injection molding. The intermediate layer 20 may basically be flatly applied onto the support component 10 or the film 30 or the skin 14 or the spacing layer 16. In any case, the intermediate layer may be provided in the region of an airbag cover, particularly on the weakening line, in order to absorb tensile forces resulting in the region of the weakening line. The intermediate layer is bonded to the decorative layer and the layer lying thereunder.

Before being applied onto the interior trim component, the decorative layer may be weakened along the weakening line from its rear side, for example, by being continuously or discontinuously scored or cut. The weakening line may be straight or have the shape of a wave, a zigzag line or the like. The weakening may be produced, e.g., by means of cutting, scarfing or grinding.

If a multilayered intermediate layer 20 is used, one of the layers can be directly applied onto the underside of the decorative layer 18 in order to hold together one or more cuts that form the weakening. A second layer can be directly applied onto the spacing layer 16 or another layer lying thereunder before the decorative layer and the layer lying thereunder are connected.

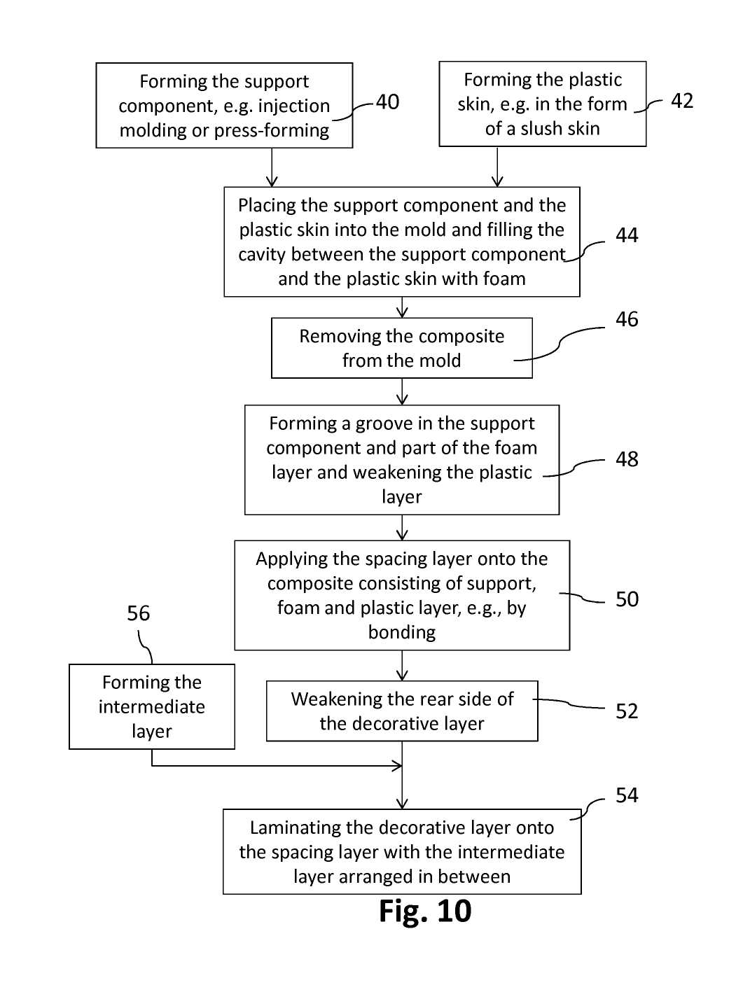

An example of a method for manufacturing an interior trim part of the type illustrated in FIGS. 1 to 9 is described below with reference to FIG. 10.

In order to manufacture the interior trim part, the support component 10 is initially formed, for example, by means of injection molding or press-forming a fiber panel, wherein all common materials such as PP, ABS, etc., including those having fiber content, natural or synthetic fiber mats, etc., may be used (step 40). In addition, the plastic skin 14 is formed, for example, by means of a slush skin forming process. For example, the skin may be made of PVC or PPO and may have a thickness on the order of 0.8 mm to 1.4 mm (step 42). The support component 10 and the plastic skin 14 are placed into a (not-shown) mold, wherein the plastic skin may serve as a shell of sorts in order to accommodate a foam material. The mold is closed and the cavity between the support component and the plastic skin is filled with foam in order to produce a composite consisting of the support component, the foam and the plastic layer (step 44). In practical applications, for example, a PUR foam is used in order to produce a foam layer with a hardness on the order of 55 to 75 Shore A.

This composite is then removed from the mold (step 46) and a groove is cut into the support component and part of the foam layer, for example, by means of a milling process in order to produce the weakening line. The plastic layer can be weakened from its upper side, for example, by means of cutting or scoring, wherein one continuous cut, individual cuts, punctiform perforations or the like may be selectively formed for this purpose (step 48).

Then, the spacing layer 16 is applied onto the composite consisting of the support component, the foam layer and the plastic skin, for example, by means of bonding, wherein this spacing layer is interrupted in the region of the weakening line (step 50). For example, a knitted or woven fabric, or a foam layer, may be used as spacing layer. It is also possible to apply individual layer segments that were produced beforehand by means of a punching process onto the composite. This may be easier than applying and subsequently cutting one continuous spacing layer.

The intermediate layer 20 is produced of a non-woven fabric layer with a thickness of about 0.1 mm that may be coated with an adhesive on both sides (step 56). For example, a thermobonded non-woven fabric may be used for this purpose. The non-woven fabric layer is provided with perforations that may be realized as illustrated in FIG. 2 or FIG. 3.

The decorative layer, which was provided with a weakening on its rear side in the region of the tear line (step 52), is then laminated onto the spacing layer, wherein the intermediate layer 20 is inserted as adhesive layer. Before its insertion, the intermediate layer 20 may be bonded to the spacing layer 16 or the decorative layer 18 or, when using a multilayered intermediate layer 20, to the spacing layer 16 as well as the decorative layer 18 or it may be connected to these two layers when the decorative layer 18 is laminated onto the spacing layer 16.

What is claimed is:

1. An interior trim part including
a support component, and
a decorative layer,
wherein the support component and the decorative layer respectively include a local weakening along a weakening line allowing to tear open the interior trim part in a controlled fashion when a predefined force is exerted upon the support component, and further including
an intermediate layer between the support component and the decorative layer, wherein the intermediate layer is bonded to the decorative layer and includes an intermediate layer weakening that intersects the weakening line.

2. The interior trim part according to claim 1, wherein the intermediate layer weakening is arranged along several parallel or essentially parallel perforation lines that extend obliquely to the weakening line at an angle other than 90 degrees.

3. The interior trim part according to claim 1, wherein the intermediate layer weakening is arranged along a first group of parallel or essentially parallel perforation lines and along a second group of parallel or essentially parallel perforation lines, and wherein the perforation lines of the first group and the perforation lines of the second group cross one another.

4. The interior trim part according to claim 3, wherein the intermediate layer weakenings along the perforation lines of the first group and the second group do not contact one another.

5. The interior trim part according to claim 4, wherein the perforation lines of the first group and the perforation lines of the second group cross one another at an angle between 90 degrees and 170 degrees, or between 90 degrees and 120 degrees.

6. The interior trim part according to claim 1, wherein the intermediate layer weakening is chosen from a group consisting of: a perforation, opening or hole that completely penetrates the intermediate layer, an opening, scoring or notching that only partially penetrates the intermediate layer or combinations thereof.

7. The interior trim part according to claim 1, wherein the intermediate layer is arranged flatly at least in the region of an airbag cover formed in the interior trim part and covers the airbag cover and the weakening line, wherein the weakening line defines the airbag cover.

8. The interior trim part according to claim 7, wherein the airbag cover includes one or more primary tear lines that are aligned along a first direction and a second direction defined by the weakening line, wherein the first direction extends perpendicular or about perpendicular to the second direction, and wherein the perforation line extends obliquely to the first direction and to the second direction.

9. The interior trim part according to claim 1, wherein the intermediate layer includes a carrier layer and one or two adhesive layers.

10. The interior trim part according to claim 1, wherein the intermediate layer includes paper, non-woven fabrics, textiles or woven fabrics.

11. The interior trim part according to claim 10, wherein the intermediate layer includes natural fibers, synthetic fibers or a mixture of natural and synthetic fibers.

12. The interior trim part according to claim 1, wherein the intermediate layer has a thickness of 0.08 mm to 0.2 mm.

13. The interior trim part according to claim 1, wherein the intermediate layer has a weight per unit area of 15 to 30 g/m³.

14. The interior trim part according to claim 1, further including a spacing layer between the support component and the decorative layer, wherein the spacing layer also includes a local weakening along the weakening line.

15. The interior trim part according to claim 14, wherein the intermediate layer lies between the decorative layer and the spacing layer.

16. The interior trim part according to claim 15, wherein an additional intermediate layer lies between the support component and the spacing layer.

17. A method for manufacturing an interior trim part, the method including:
providing a carrier layer the carier layer including a local weakening,
coating the carrier layer with an adhesive to produce an intermediate layer with an adhesive layer on each side of the carrier layer,
providing a support component and a decorative layer, the support component and the decorative layer respectively including a local weakening along a weakening line allowing to tear open the interior trim part in a controlled fashion when a predefined force is exerted upon the support component,
providing a spacing layer, and
producing a sandwich structure of the support component, the spacing layer and the decorative layer, wherein the spacing layer and the decorative layer are bonded to one another by means of the intermediate layer, wherein the local weakening of the carrier layer intersects the weakening line.

18. The interior trim part according to claim 2, wherein the perforation lines extend obliquely to the weakening line at an angle of 20 degrees to 70 degrees, or 30 degrees to 60 degrees.

19. The interior trim part according to claim 12, wherein the intermediate layer has a thickness of about 0.1 mm.

20. The interior trim part according to claim 13, wherein the intermediate layer has a weight per unit area of about 20 g/m³.
